(19) United States
(12) Patent Application Publication
(10) Pub. No.: US 2006/0031817 A1
(43) Pub. Date: Feb. 9, 2006

(54) Integrated dynamic control flow and functionality generation for network computing environments

(76) Inventor: Friedrich Pieper, Ulm (DE)

Correspondence Address: KENYON & KENYON, ONE BROADWAY, NEW YORK, NY, 10004, US

(21) Appl. No.: 11/245,897

(22) Filed: Oct. 6, 2005

Related U.S. Application Data
(63) Continuation of application No. 09/766,215, filed on Jan. 19, 2001.

(51) Int. Cl. G06F 9/44

(52) U.S. Cl. 717/107

(57) ABSTRACT

A computer system for automatically generating a process step has a meta data definition storage which includes a definition of the process step to be generated, a process generator for generating the process step on the basis of the definition in the meta data definition storage, an application data storage for storing application data, the application data being linked in accordance with a data logic and a runtime meta data storage for storing the data logic of the application data, a runtime environment for accessing the application data on the basis of the data logic and executing the process step using the application data by means of a first function where the first function is specified in the meta data definition storage.

### BACKGROUND OF THE INVENTION

Automatic application generation has been in use since the early days of Software Development. First relevant technologies in this field were compilers and interpreters which over time were enriched with various other supplemental technologies. These technologies and their environment always had to achieve two objectives when creating executable code: include actual data, that is application data according to data definitions; and sequence executable process elements, whether these were single statements, lines of code, modules, or in modem times so-called work flow steps. Over time many methods and computer systems have been included in the ever progressing environment of automated application generation, as exemplified by databases, data item catalogues, meta data, repositories and workflow control methods.

However, this modern state of the art exhibits technical bottlenecks. For example, a major modern software concept, workflow, however appealing its functionalities are, has by now in many cases proven to be difficult to implement, and consequently has not been able to draw the broad interest and use which it could earn.

There are two major reasons for this phenomenon: First, traditional data handling technologies make it difficult to solve the integrative middleware task to include data from a variety of sources into one data model. Second, it is difficult to include such data in programmed complex functionalities which can be operated and maintained easily in flexible computing network architectures.

In detail, there are problems associated with integrating data from existing programs, databases or systems and making them available for a new process step or a new workflow application and to immediately and automatically create a process step and/or workflow process.

### SUMMARY OF THE INVENTION

The present invention is directed to a computer system for automatically generating a process step, comprising a meta data definition storage containing a definition of the process step to be generated and a first function, a process generator for generating the process step on the basis of the definition in the meta data definition storage, an application data storage for storing application data, the application data being linked in accordance with a data logic, a runtime meta data storage for storing the data logic of the application data, and a runtime environment for accessing the application data on the basis of the data logic and executing the process step using the application data by means of the first function specified in the meta data definition storage.

The present invention also directed to a method of generating a process step, comprising the steps of selecting a definition of the process step to be generated from a meta data definition storage, generating the process step on the basis of the definition selected from the meta data definition storage, reading out a specification of a first function to be implemented in a runtime environment from the meta data definition storage, reading out a data logic of application data from a runtime meta database, accessing application data on the basis of the data logic stored in the runtime meta database, and executing the process step in the runtime environment using the application data by means of the specification of the first function read out from the meta data definition storage.

The present invention is also directed to a computer memory encoded with executable instructions representing a computer program for generating a process step, comprising means for selecting a definition of the process step to be generated from a meta data definition storage, means for generating the process step on the basis of the definition selected from the meta data definition storage, means for reading out a specification of a first function to be implemented in a runtime environment from the meta data definition storage, means for reading out a data logic of application data from a runtime meta database, means for accessing application data on the basis of the data logic stored in the runtime meta database, and means for executing the process step in the runtime environment using the application data by means of the specification of the first function read out from the meta data definition storage.

The present invention is also directed to a computer-readable medium for storing a plurality of instruction sets for causing a computer system to generate a process step by performing the steps of selecting a definition of the process step to be generated from a meta data definition storage, generating the process step on the basis of the definition selected from the meta data definition storage, reading out a specification of a first function to be implemented in a runtime environment from the meta data definition storage, reading out a data logic of application data from a runtime meta database, accessing application data on the basis of the data logic stored in the runtime meta database; and executing the process step in the runtime environment using the application data by means of the specification of the first function read out from the meta data definition storage.

Preferably, the computer readable medium according to the present invention is a data carrier that can be read by a computer such as a floppy disk, a CD-Rom, an optical storage or the like and the set of instructions was written in a programming language such as Java, C++, Modula or the like, and is stored on the computer readable medium in compiled or uncompiled form.

### BRIEF DESCRIPTION OF THE DRAWINGS

FIG. 1 shows a structure of an exemplary computer system according to the present invention.

FIG. 2 shows an exemplary processing method according to the present invention carried out in the computer system of FIG. 1.

FIG. 3 shows an exemplary structure of a meta data level in the computer system of FIG. 1, according to the present invention.

FIG. 4 shows an exemplary runtime environment in the computer system of FIG. 1, according to the present invention.

FIG. 5 shows the interrelation of a runtime meta data storage and a process step in the computer system of FIG. 1, according to the present invention.

FIG. 6 shows a block diagram of an exemplary search engine in the computer system of FIG. 1, according to the present invention.

FIG. 7 shows an exemplary data acquisition and an exemplary learning of new data connections in the computer system of FIG. 1, according to the present invention.

FIG. 8 shows an exemplary log-in procedure carried out in the computer system of FIG. 1, according to the present invention.

FIG. 9 shows an exemplary process selection in the computer system of FIG. 1, according to the present invention.

FIG. 10 shows exemplary entries in an exemplary meta database in the computer system of FIG. 1, according to the present invention.

FIG. 11 shows an exemplary representation generated by an exemplary process step generated in the computer system of FIG. 1, according to the present invention.

FIG. 12 shows an exemplary anode table in the computer system of FIG. 1, according to the present invention.

### DETAILED DESCRIPTION

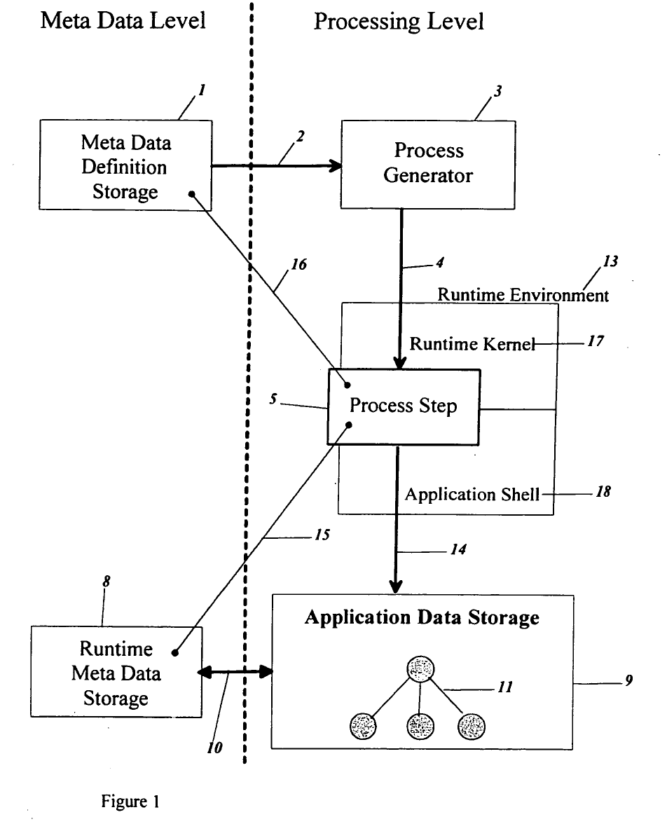

The exemplary embodiment according to the present invention will now be described with references to FIGS. 1-12. FIG. 1 shows the logic structure of an exemplary computer system according to the present invention. Logic components of this computer system are as follows:
a first database server (meta data definition storage);
a runtime server corresponding to
1 or many runtime clients (process step presentation and execution) communicating with
1 or many application data servers; and
a second database server (runtime meta data storage).

The above components are typically distributed in a local or wide area network, but may also reside (in very simple cases) on one single computer. This single computer may be a Personal Computer (for example IBM™, Compaq™, Dell™, HP™. . . ) with 128 MB memory Pentium CPU, a 8 GB hard disk with Microsoft Windows™ NT 4.0 Workstation, Service Pack 4, Microsoft SQL Server 7.0 with ODBC, JDBC, a Web Browser, for example Microsoft Internet Explorers 5.0 and a Java Runtime Engine, for example Apache's Tomcat jre. The physical arrangement of these components is known in the art. Therefore, the indication of these components in FIG. 1 has been omitted for the shake of clarity.

The logic structure depicted in FIG. 1 is divided into a meta data level on the left side of the dashed vertical line and a processing level on the right side of the dashed vertical line. Reference numeral 1 in FIG. 1 designates a meta data definition storage containing a plurality of definitions for meta data. Furthermore, the meta data definition storage 1 comprises of a definition of a process step that is to be generated by the system depicted in FIG. 1. As indicated by arrow 2 in FIG. 1, the meta data definition storage is linked to a process generator 3. The link indicated by arrow 2 between the meta data definition storage 1 and the process generator 3 can be of any kind allowing the process generator 3 to access the definition of a process step 5 stored in the meta data definition storage 1. The process generator 3 is adapted for generating the process step 5 on the basis of the definition in the meta data definition storage 1. On the meta data level of the system depicted in FIG. 1, there is a runtime meta storage 8 for storing a data logic of application data stored in an application data storage 9. In the application data storage application data is stored, i.e., linked in accordance with the data logic in the runtime meta data storage 8. Typically, the data logic, shown with reference number 11, is hierarchical with a master node and a plurality of child nodes. This structure is purely abstract and is specified in the runtime meta data storage 8. A link between the application data storage 9 and the runtime meta data storage 8 is indicated by arrow 10.

As indicated by arrow 4, the process step 5 generated by process generator 3 is given to a runtime environment 13. The runtime environment 13 is arranged for accessing the application data in the application data storage 9 through a link to the application data storage 9 indicated by arrow 14. The runtime environment accesses the respective application data in the application data storage 9 on the basis of the data logic stored in the runtime meta data storage 8 which is acquired by the runtime environment trough a further link 15. The runtime environment 13 executes the process step 5 by means of a function using the application data. A definition of the function is specified in the meta data definition storage 1. The runtime environment acquires the definition of the function through a further link indicated by arrow 16. Furthermore, the runtime environment 13 is adapted to determine whether the function is a standardized, application-independent function or an application-dependent function.

As shown in FIG. 1, the runtime environment 13 comprises a runtime kernel 17 and application shell 18. The runtime kernel 17 is adapted to execute the function when the first function is a standardized, application-independent function. The application shell 18 is adapted to execute the function when the function is an application-dependent function.

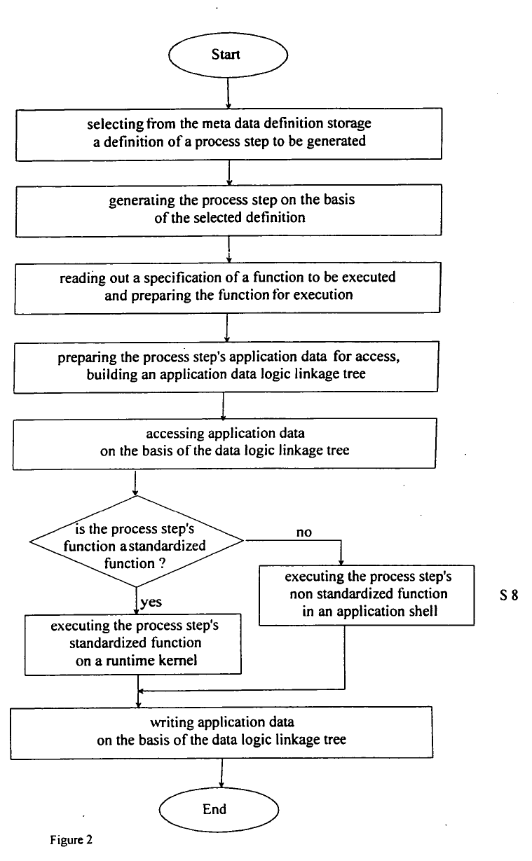

FIG. 2 shows an exemplary processing method carried out in a computer system with the logic structure depicted in FIG. 1. After the start in step S1, a definition of the process step to be generated is selected from the meta data definition storage 1 in step S2. The actual selection of the process step to be generated is made on the basis of the context of the application. Then, the processing continues to step S3. In step S3, the process step 5 is generated in the process generator 3 on the basis of the definition selected from the meta data definition storage 1 and handed to the runtime environment 13. In the following step S4, a specification of a function of the process step 5 to be implemented in the runtime environment 13 is read out from the meta data definition storage 1. In step S5, the data logic of the application data in the application data storage 9 is read out from the runtime meta data storage 8. In the following step S6, the runtime environment 13 accesses the application data in the application data storage 9 on the basis of the data logic read out from the runtime meta data storage date read out in the process step 5. In the following step S7, a determination is made in the runtime environment 13 whether the function of the process step is a standardized, application-independent function or an application-dependent function. In case the function is a standardized, application-independent function, the processing continues to step S9. In step S9, the runtime kernel 17 executes the function of process step 5 using the application data by means of the function specified in the meta data storage 1. Then, the processing continues to step S10, which involves writing application data on the basis of the data logic into the application data storage 9 and ends in step S11.

In case the function is a not a standardized, application-independent function but an application-dependent function, the processing continues from step S7 to step S8. In step S8, the application shell 18 executes the function of process step 5 using the application data by means of the function specified in the meta data storage 1. Then, the processing continues to step S10 and ends in step S11.

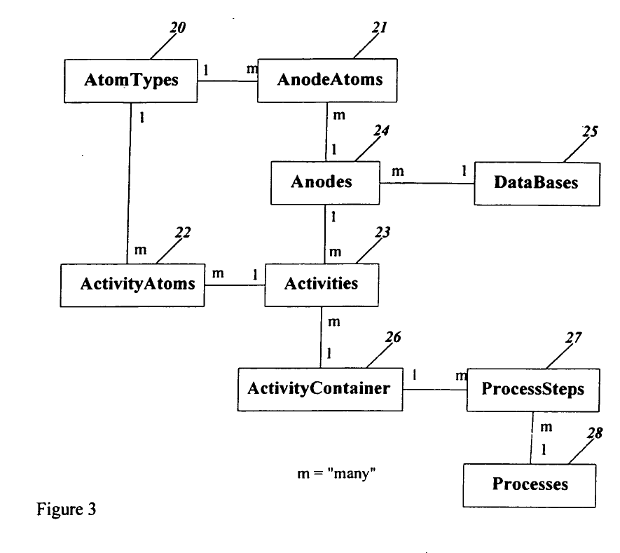

In the following, the computer system of FIG. 1 will be described in more detail with reference to FIGS. 3-6. In these figures, corresponding elements are designated with the same reference numerals in order to avoid an unnecessary repetition of the description of these elements. FIG. 3 shows an underlying structure of the meta data level on the left side of the vertical dashed line in FIG. 1, i.e., an exemplary structure of the meta data in the meta data definition storage 1. FIG. 3 uses the well known entity relationship (ER) model. The meaning of a “1:m” denoted line is a “one to many relationship,” for example “many anode atoms may be derived from one atom type” (see below). The use of “m” denoting the relationships between the respective elements in FIG. 3 does not imply that all relationships in FIG. 3 denoted with “m” have the same number of relationships.

Reference number 20 designates the basic objects of the data which will be called atom types in the following. Atom types are not derived from any object type except that they are already typified with the respective data type attributes such as char*, num, daytime, etc. In the meta database, that is in the meta data definition storage 1 and the runtime meta data storage 8, it is possible to design and describe a plurality of atom types and to add execution rules or domain rules. Examples of atom types are names of persons, names of cities, the legal form of a corporation (Inc., AG, GmbH) or a zip code.

From the atom types 20, a plurality of anode atoms and a plurality of activity atoms 22 are derived. Each anode atom and each activity atom must be derived from an atom type, but many anode atoms and/or many activity atoms may be derived from one atom type.

Atoms are members of anodes and activities. An anode (“atom node”) is the data representation, and an activity is the processing representation of a set of atoms. An anode can be implemented as a table in a RDBMS, and an activity can be implemented as a screen mask.

As shown in FIG. 3, a set of anode atoms 21 is instantiated in one anode 24. All members of an anode 24 have to be specified as anode atoms 21. Each anode is a member of exactly one database 25 comprising application data. For example, database 25 is a RDBMS or a legacy database system and can be located at any place in a LAN, WAN, Intranet or in the Internet. Many anodes 24 may be members of one database 25.

A plurality of activity atoms 22 is instantiated in one activity 23. Typically, most of the activity atoms are inherited from the anode to which the activity is linked. An activity is linked to at most one anode. There are activities without an anode, but also an activity with an anode may have some further atoms. In this respect, each atom of an activity 23 has to be specified either as anode atom 21 or as activity atom 22. Many activities 23 may be linked to one anode 24.

A plurality of activities 23 are linked to a common activity container 26. In the exemplary case of the activity 23 being a screen mask, the activity would be part of a screen mask and all or some of its atoms would be data fields in the screen mask. Due to the structure depicted in FIG. 3, each of the activities 23 in the activity container 26 “knows” all atoms of the other activities 23 in the same activity container 26 and is able to perform a specified access to all of these atoms. The access rules for such an access are stored in the meta data definition storage. Anodes can be linked to each other by defining one activity corresponding to each anode of the anodes to be linked and defining one activity container 26 containing these activities. All activities of an activity container know all atoms of each other. But there are simple container access rules in the meta data definition storage 1 to define anode access between different containers 26.

The activity container 26 corresponds to an application process step in the execution model representation. This is shown in FIG. 3 in such a way that each activity container 26 is linked to a plurality of process steps 27. Each process step 27 is linked to at most one activity container 26 and there may exist simple steps 27 without an associated activity container 26. Since process steps have rules in the meta data definition storage I defining processing properties, it is advantageous that many process steps 27 are linked to the same activity container 26.

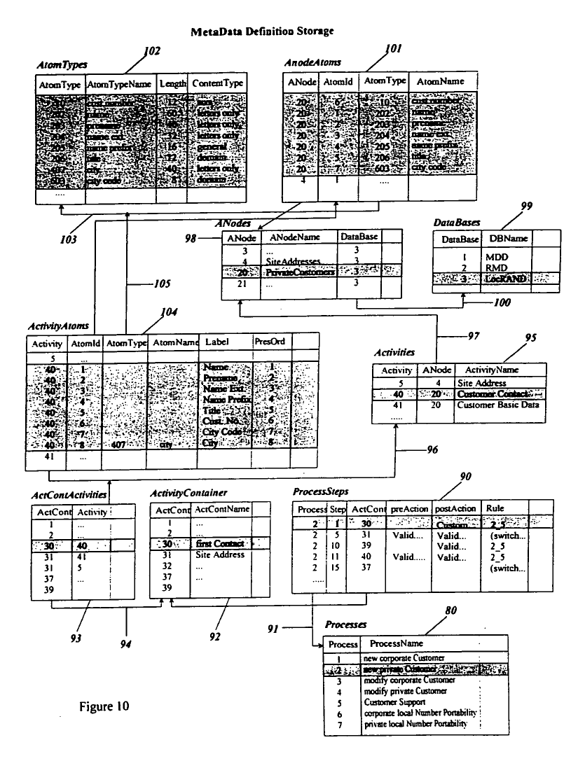

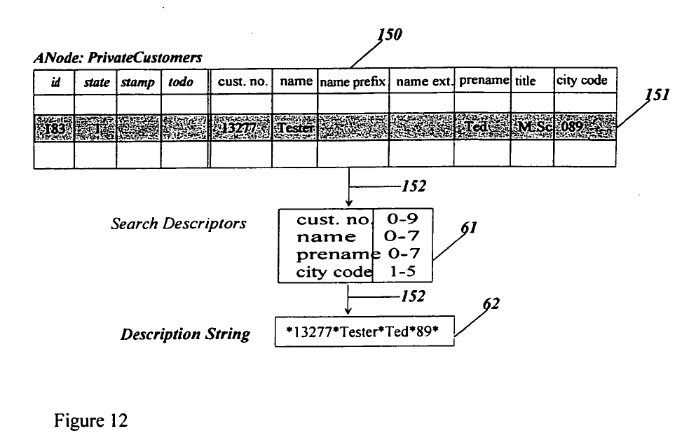

As shown in FIG. 3, a plurality of process steps 27 form a process 28. The rules concerning the connections between the activity container 26, the process steps 27 and the process 28 are set forth in the runtime environment 13. These rules contain the information on how a plurality of activity containers 26 actually become a process 28. The structure of the meta data will be further described with reference to FIG. 10 and 12.

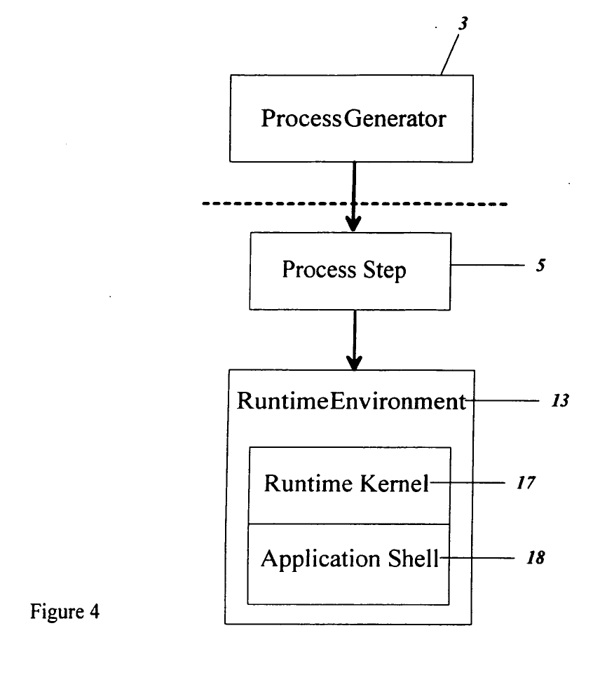

FIG. 4 shows the arrangement of the process generator 3 and the runtime environment 13 of FIG. 1 in more detail. As already mentioned with reference to FIG. 1, a process step 5 generated by the process generator 3 becomes executable by putting it into the runtime environment 13. The runtime environment 13 comprises the runtime kernel 17 and the application shell 18. The runtime kernel 17 is application-independent and the application shell 18 is implemented for application-specific functions. The interrelationship between the process generator 3 and the runtime environment 13 is flexible and supports all of the known execution models as, for example, the object creation at runtime, the interpretation at runtime, and the source (script) generation and different steps. The main purpose of the arrangement of the runtime kernel 17 and the application shell 18 in the runtime environment is to completely separate application-dependent functionalities of the runtime environment 13 from application-dependent functionalities while allowing for the full inclusion of the environment into automatic process generation and automatic application generation. The runtime kernel 17 implements the functions (or methods) specified in the meta data definition storage 1 which are assumed to be constant and invariable over a great number of applications. The functions implemented by the runtime kernel 17 are referred to as basic functions.

The basic function of the runtime kernel 17 always comprise the interface for accessing the application data from the application data storage 9. This interface is strictly standardized for the runtime kernel 17. Further, by knowing the respective enode and atom to be accessed by a specific process step 5, this process step 5 is able to access these anodes and atoms using the standardized interface in the runtime kernel 17. Further, the interface for the application data forms the mapping to the respective application database 25 which is accessed. Examples of the basic functionality of the runtime kernel 17 is the type examination and domain validation of data fields in screens, and the incorporation into execution models such as workflow, work group environments. etc.

In accordance with the pragmatic separation of the runtime kernel 17 and the application shell 18, the application shell 18 implements functions (or methods) from which it is assumed that there are used seldomly. When the process step 5 is put into the runtime environment 13, the runtine environment 13 determines whether a function required by process step 5 to be executed and specified in the meta data definition storage 1 is part of the basic function of the runtime kernel 17, or not, In other words, the runtime environment 13 performs a test whether the respective function required by the process step 5 is a standardized application-independent function or an application-dependent function. If the function of the process step 5 is part of the basic function, that is, a standardized application-independent function, the process step 5 is executed with this function on the runtime kernel 17. On the other hand, if this function is an application-dependent function and not part of the basic function of the runtime kernel 17, process step 5 is executed with this function on the application shell 18.

In case the process generator 3 works in a compiling environment, the runtime environment 13 provides the operating environment for compiled applications. Such an operating environment is executable in all kinds of selected system environments. The runtime kernel 17 and the application shell 18 are preferably realized as object libraries which are linked after compilation to the respective applications such that they are executable in the respective system environment.

In the case of an interpreting environment (such as Java), functionality is instantiated at runtime, or generated into applets or into servelets.

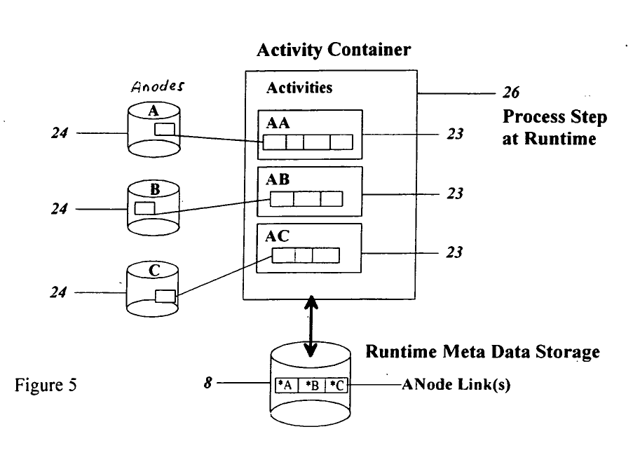

FIG. 5 shows the interrelation of the runtime meta data storage 1 and the process step 5 in the computer system of FIG. 1 in more detail. Reference number 26 in FIG. 5 designates an activity container which is in the execution model of the process step 5. The activity container 26 comprises a plurality of activities 23 and in the specific example shown in FIG. 5, the activity container 26 comprises three activities, namely activity 23 AA, activity 23 AB and activity 23 AC. The activities are respectively linked to anodes. In the example depicted in FIG. 5, activity 23 AA is linked to anode 24 A, Activity 23 AB is linked to anode 24 B and activity 23 AC is linked to anode 24 C. To execute the three activities 23 AA, AB and AC in the activity container 26 in FIG. 5 and to further execute the process step, the runtime environment 13 accesses the runtime meta data storage 8 and accesses the data logic of the application data needed for the execution. The data logic of the application data comprises the respective anode links. Due to the data logic comprising respective anode links of the respective activities 23 in the activity container to the respective anode 24, each activity 23 AA, AB, AC can now access the respective anode 24 A, B and C. In other words, when activity 23 AA is executed requiring access to application data items represented by anode 24 A, the runtime environment 13 accesses the runtime meta data storage 8 containing the data logic of anode 24 A and then accesses application data items represented by anode 24 A on the basis of the data logic.

This allows advantageously to reconstruct the data logic of a particular anode 24 independently from the actual access to the respective database 25. In other words, independently of the actual access to the respective application data storage 9, the meta data storage ‘knows’ the location of the data items in this application data storage 9.

Furthermore, since each anode link of every possible activity 23 is stored in the runtime meta data storage 8, activity 23 requiring a data item represented in one of the anodes 24 may access this data item by simply accessing the data logic, that is the anode link in the runtime meta data storage 8. Thus, each application data item in the database 25 which is linked to an anode 24 whose anode link is stored in the runtime meta data storage 8 can be found and/or located without actual access of this particular data item in the database 25.

Advantageously, the computer system according to the present invention allows to focus the programming efforts and expenditures during the development of an application on the modeling of the application shell 18. Furthermore, the modeling efforts and expenditures during the development of a new application can be focused completely on the entries of the meta data definition storage 1 and the runtime meta data storage 8. In addition to that, the above described interaction of the meta data definition storage 1, the runtime meta data storage 8 and the process generator 3 allows a completely automatic and dynamic generation of even complex processes. The process steps 5 generated the process step generator 3 are executable in the runtime environment 13 without requiring manual intervention. In addition to that, due to the flexibility and the transparency of the meta data and the meta data definition storage 1 and the runtime meta data storage 8, it is possible to easily generate process steps 5 for different runtime environments 13 such as HTML, Java™ Servelets, Java™ Runtime Environments and script generation in program languages such as C++. Furthermore, development of new applications is simple and relatively easy since the development is finished with the descriptive modeling of the respective function of the process step 5 of the new application on the meta data level, that is, in the meta data definition storage 1 and the runtime meta data storage 8. Due to this, the testing time for the new application is reduced significantly since the test of the new application can be limited to the test of the functions for the process steps 5 specified in the meta data definition storage 1 and the runtime meta data storage 8. In case a new application-specific function has to be added to an already existing system, all amendments that have to be made to the existing system have to be made to the application shell 18 only.

In case an amendment has been made to the application shell 18, and an application-specific function has been added thereto, it is simple and uncomplicated to perform the testing of this new function since this function is tested in a known and stable environment. Furthermore, the technical support for the user is reduced significantly since it can be reduced to the exchange of the process generator 3 and to entries of the meta data in the meta data definitions storage 1 and the runtime meta data storage 8.

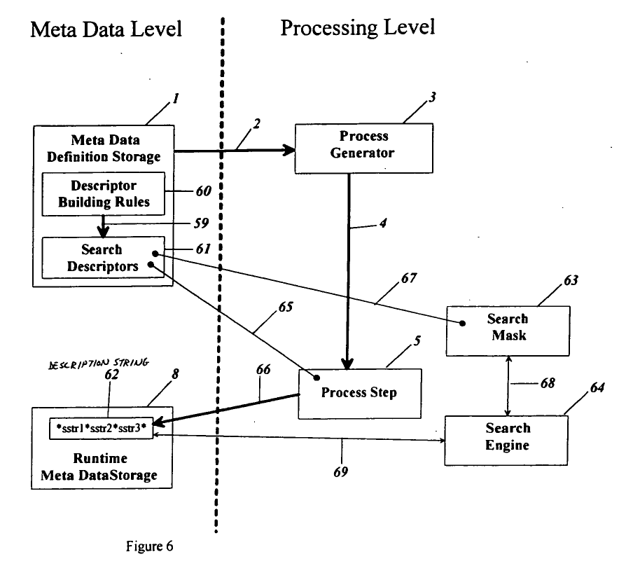

FIG. 6 depicts a structure and a processing method of an embedded search engine 64 in the computer system with the structure depicted in FIG. 1, according to the present invention. On the left side of the dashed vertical line in FIG. 6, there are depicted elements on the meta data level, and on the right side of the dashed vertical line in FIG. 6, there are depicted elements on the processing level. In addition to the structures in meta data definition storage 1, whose contents enable process generator 3 to completely generate process step 5 and which were already described above, specific structures are provided there for an intelligent case search. These structures are made up of descriptor building rules 60 and of search descriptors 61 generated therefrom. Search descriptors 61 can be specified for each anode. Arrow 59 denotes the process of generating the search descriptors for process step 5. Process generator 3 also generates these search descriptors 61 in process step 5, as indicated in FIG. 6 by connecting line 65. Based on the knowledge of these search descriptors 61, process step 5 (i.e., its runtime environment 17), “knows” how to generate its characteristic description string 62 which is stored in the runtime meta data storage. This process of generating description string 62 is indicated by arrow 66.

In FIG. 6, the assumption is made that—as stipulated by search descriptors 61—description string 62 is to be formed, for example, from the three substrings sstr1, sstr2 and sstr3, which are each separated by “*”. Description string 62 is generated once execution of process step 5 is complete and the application data (reference numeral 14 in FIG. 1) and the anode links (reference numeral 10 in FIG. 1) are written. Of course, it is generated for the application data record just created, since,.after all, characteristically, it is supposed to be written into the runtime meta data. For that reason, these details shown in FIG. 1 are not repeated again here in FIG. 6.

At any later point in time, for instance when a user would like to search for a specific case stored here, search engine 64, using the same search descriptors 61, can generate a search mask 63 (generation illustrated by connections 67 and 68). An appropriate description string 62 is then generated on the basis of the pieces of information input during a search dialog into this search mask 63 which comparable to the storing of data in process step 5 (see arrow 66). Furthermore, it is possible to perform a consistency check to see if this description string conforms with all description strings 62 (more precisely: those produced in accordance with the same search descriptors) stored in the runtime meta data storage. This comparison process is denoted by double arrow 69.

As the end result of the case search, the search engine places the located anode record in the activity container (and its activity) which had produced this anode record. In so doing, the same process step (that had presented this activity container) can be reactivated. However, another process step can also be activated, which had been modeled for the subsequent processing and supplementation of a case. Thus, the search engine not only provides cases with their data for selection, but also various process steps (to the extent modeled for the located case), in order to process the case.

The search engine 64 is implemented exclusively on the runtime meta data storage 8. The description strings 62 of the individual anode records do not reside with the anodes in the application data storage 9, but rather in the runtime meta data storage 8. The description strings 62 have a very high recognition value (provided, of course, that during the design, one selected the characteristic atoms of the anode in question) and “know” their context, i.e., time stamp, anode record ID, process step ID, user ID, etc., are stored, together with the description strings, in the runtime meta data storage 8.

Apart from the implementation of the search engine 64 as described above, other possible implementations of search engines on the basis of runtime meta data, for example thesauri, and AI (artificial intelligence) methods for linking the search descriptors can be implemented with known methods. Furthermore, it is possible to subsequently extract search descriptors and description data in a runtime meta data storage, which is generated for existing databases, to make these accessible to an intelligent search service.

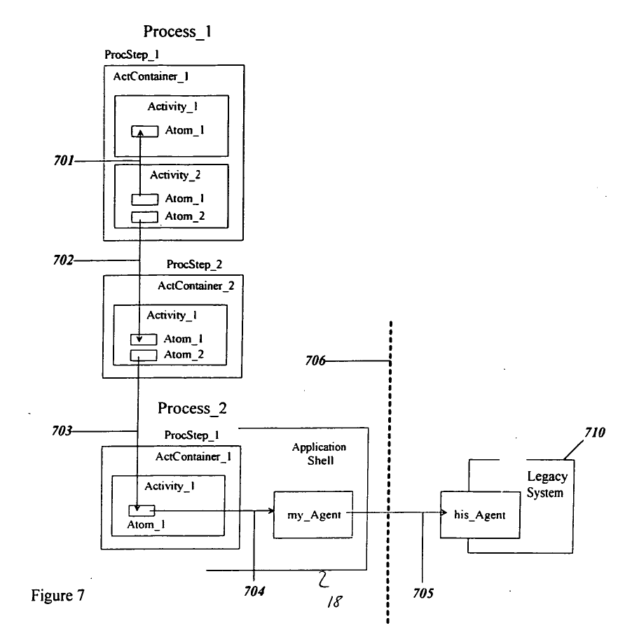

FIG. 7 shows an exemplary data acquisition and an exemplary learning of new data connections in the computer system of FIG. 1, according to the present invention. FIG. 7 also illustrates an exemplary embodiment of data relations between various processes, their process steps, their activities, and atoms. In FIG. 7, there are depicted a first process Process_1 including process step ProcStep_1 and process step ProcStep_2, and a second process Process_2 including a further process step ProcStep_1. In Process_1, process step ProcStep_1 contains an activity container ActContainer_1 including an activity Activity_l and an activity Activity_2. Activity Activity_1 comprises an atom Atom_1, and activity Activity_2 comprises an atom Atom_1 and an atom Atom_2. Activity container ActContainer_2 comprises an activity Activity_1 comprising further atoms Atom_1 and Atom_2. Process Process_2 comprises an activity container ActContainer_1 with an activity Activity_1 which comprises a further atom Atom_1. The connection to a legacy system 710 is implemented by application shell 18. This will now be described with more detail.

In the meta data definition storage 1, for process steps, activities, and atoms, rules can be modeled which are invoked at significant processing points (e.g., prior or subsequent to the processing of an atom; prior or subsequent to the execution of an activity of a process step, etc.). The rules are formulated in a LISP notation and are executed by a LISP interpreter in the runtime kernel 17. To clearly designate the objects involved, the method of “qualifiers” is applied, as is customary in all popular programming languages and, e.g., also in file directories.

The arrow having reference number 701 indicates that the Atom_1 of Activity_2, which will be designated Process_1.ProcStep_1.Activity_2.Atom_1, obtains its valid value from Atom_1 in Activity_1 in the same activity container ActContainer_1 (which here, however, is qualified via its process step ProcStep_1, because the resolution of the qualifier is a matter of the process control, not of the presentation level). To this end, for Process_1.ProcStep_1.Activity_2.Atom_1, the rule is stored in the Meta data definition storage:
Atomvalue(Activity_1.Atom_1)

The qualifier is already unambiguous on the activity level, thus it no longer needs to contain process step and process.

For the next atom, namely Process_1.ProcStep_1.Activity_2.Atom 2, however, the value should be extracted from another process step of the same Process_1. This is indicated by arrow 702. For that reason, at this point, the process step in the qualifier is also named, i.e., the rule for Process_1.ProcStep_1.Activity_2.Atom_1 says:
Atomvalue(ProcStep2.Activity_1.Atom_1)

Here, one can discern that it is important, in the qualifier, to reference the process step and not its activity container. This is because there is the possibility that the referenced process step (in this case: ProcStep2) still has not been executed at all for the required atom. This can only be ascertained from the context of the referenced process step. The invoking of a referenced process step from such a context is then, if needed, dynamically generated and executed.

Arrow 703 indicates that it may even be necessary to dynamically generate and execute a new process using one (or a plurality) of the required process steps. As indicated by arrow 703, the atom Process_1.ProcStep_2.Activity_1.Atom_2 obtains its value on the basis of the rule:
Atomvalue(Process2.ProcStep1.Activity_1.Atom_1)

The atom referenced here Process2.ProcStep1.Activity_1.Atom_1 should, in turn, obtain its value from a legacy system. For this, in the application shell 18 for the activity process2.ProcStep1.Activity_1, an interface class “my_Agent” is implemented, which has the task of undertaking the exchange of objects with the legacy system, as required by this system. The computer system according to the present invention has prepared interface conventions for integration problems of this kind. As indicated by arrow 704, the activity Process2.ProcStep1.Activity_1 invokes the following method or function:
my_Agent fetch(“Atom_1”)

At this point, this method or function “my_Agent fetch” executes (as indicated by arrow 705) the object transfer with the legacy system. To this end, a corresponding agent “his_Agent” must be implemented and embedded in the legacy system. As a rule, this is a customized system implementation. “My_Agent” and “his_Agent” need, in particular, to construct, i.e., to protect, the context for the record identification and object selection, on the part of the legacy system. Dividing line 706 characterizes the system disruption that the computer system according to the present invention, with its class “my_Agent,” has to overcome. Since this takes place dynamically, arrow 703 does not need to be considered, which is why the referenced atom Process2.ProcStep1.Activity_1.Atom_1 obtains its value.

The method illustrated in FIG. 7 makes any objects at all “known” in the computer system according to the present invention. The object communication “my_Agent” —“his_Agent”, presented by way of example, can also carry out a much simpler mapping (because it is a conforming mapping in the computer system according to the present invention) between remote end local atoms of various computer system installations according to the present invention. As shown in FIG. 7, even such a mapping then makes “remote atoms” “locally accessible” in the same sense. This process of making new atoms accessible takes place dynamically. Therefore, the computer system according to the present invention and the respective method according to the present invention have the capability of making new data objects accessible in a self-learning operation.

### EXAMPLE

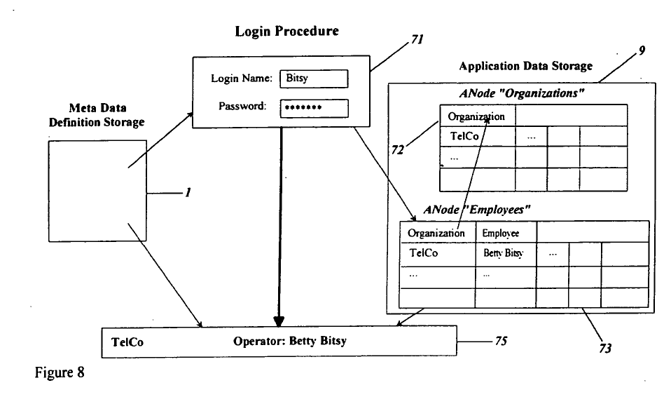

In the following, a detailed example of the computer system of FIG. 1 and the corresponding method will be described with reference to FIGS. 8-12 which illustrate to an exemplary process step “first contact” of a process “new private customer.” The process step “first contact” of the process “new private customer” is part of a telephone-number-management system. The system and method described in the following is adapted and applied to a HTTP-server system in which a Java™ Runtime environment, such as Tomcat™, is installed, which instantiates the objects referenced in the meta database comprising the meta data definition storage 1 and the runtime meta data storage 8 dynamically, and generates respective HTML-pages. The HTML-pages filled in by a HTTP client on a HTML browser are processed in the dynamically instantiated Java environment on the HTTP server.

FIG. 8 shows an exemplary login procedure. During this procedure, it is verified whether user BETTY BITSY at the HTTP client with the respective password is allowed to login; if user BITSY is allowed to log in, a header for each following process is modeled, i.e. generated. In this login procedure, the definition of the process step “login procedure” to be generated is first selected from meta data definition storage 1. The process generator 3 generates the respective process step 5 on the basis of the definition selected from the meta data definition storage 1. Since the process step “login procedure” is a standard function, this process step will be executed in the runtime kernel 17. The runtime kernel 17 reads out the specification of the respective standard function to be implemented from the meta data definition storage 1. Then, a login screen, the representation of which has just been read from the meta data definition storage 1, is sent to the HTTP client. The login screen is designated with reference number 71 in FIG. 8. When the login screen 71 is filled out by the user on the HTTP client, and has been sent back to the HTTP-server, the runtime kernel 17 accesses its respective anodes 72 and 73 in an application data storage 9. The current process step 5 in the runtime environment 13 “knows” its anodes and the location of the anodes in the application data storage 9 and the location of the application data storage 9 from the data logic read out from meta data definition storage 1.

In FIG. 8, anode 73 represents the employees of specific organizations. In the following example, the user with the login name BETTY BITSY is an employee of an organization with the name “TelCo.” Anode 72 comprises the atom organization, which, in the following, is the organization TelCo. Thus, the respective anode link links the anode 73 to the anode 72. In relational terminology, this is referred to as foreign key/primary key relation. This anode link, that is the data logic of the respective application data in the application data storage 9, is stored in the runtime meta data storage 8. Accordingly, the data logic of the application data storage 9 is “known” to the all subsequent process steps. In other words, it is “known” to all subsequent process steps, from the runtime meta data in the storage 8, that BETTY BITSY is an employee of the organization TelCo.

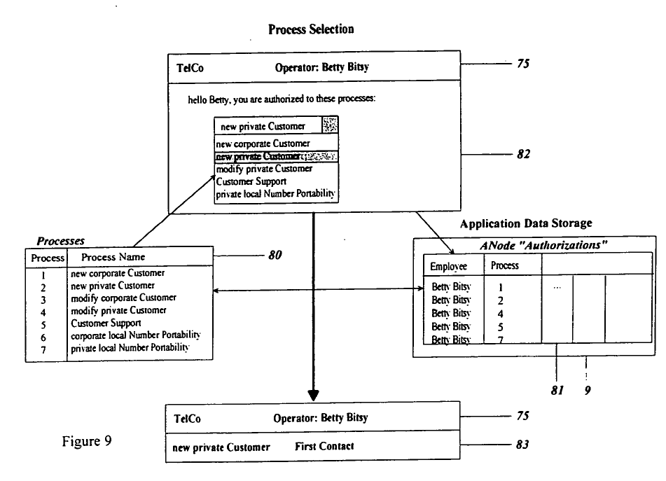

It is verified in the login procedure depicted in FIG. 8, whether the password entered by the user BETTY BITSY is actually the valid password. Since this is done in the same way as it is verified that BETTY BITSY is an employee of the organization TelCo, this step is not described in further detail. After having verified the password and the user BETTY BITSY, the runtime kernel 17 in the runtime environment 13 interprets the rules for selecting the next process step 5 and writes the corresponding information into the runtime meta data storage 8, i.e. into a to-do-list, so the workflow manager will start the next step at any time later. For all subsequent steps the context is known from processing the above process step, so the process generator 3 models the header for the subsequent processes depicted with reference number 75 in FIG. 8. FIG. 9 shows an exemplary process selection in the system of FIG. 1. Reference number 80 shows a table in which a plurality of processes are modeled. Table 80 is stored in the meta data definition storage 1. As can be gathered from table 80 in FIG. 9, the processes are set forth in the table with one record per process, including the respective primary key “process” and the process names. During the execution of this process step in the runtime environment 13, the runtime environment accesses the application data storage 9 and therein the anode “authorizations” designated by reference 81 in FIG. 9, in order to find out for which of the processes stated in Table 80 the user BETTY BITSY is actually authorized. This information, shown in anode 81, is actually stored in the application data storage 9. Thus, only those processes for which BETTY BITSY is actually authorized are therefore dynamically generated into the HTML page sent to the client. Reference number 82 shows the screen mask that is shown to the user which shows only those processes, of the processes stated in table 80, to which the user BETTY BITSY is authorized. In the depicted example, the user selected the process “new private customer.” Thus, the process generator 3 will model a further header 83, which is added to the header 75 modeled in the login procedure.

FIG. 10 shows in detail exemplary entries in the meta data definition storage 1, from which respective Java™ objects on a server are dynamically instantiated and the HTML page for a process step “first contact” for the transmission to the client are generated. Reference number 80 designates the table with the processes that have already been described with reference to FIG. 9. As first described with reference to FIG. 9, the process of “new private customer” has been selected. In addition to the attributes shown in Table 80, this table may further comprise additional attributes which specify important characteristics of these processes, such as whether the respective process is a hidden process, a background process or a visible process, whether it is a process to which only an administrator has access, or whether the respective process is external-event or internal-event driven.

Table 90 is a process step table, in which the attribute process and the attribute step are primary keys. The other attributes “ActCont,” “preAction,” “postAction,” and “Rule” are execution-orientated attributes. As indicated by Arrow 91 in FIG. 10, the attribute “process” in Table 90 is foreign key with respect to the primary key “process” in Table 80. In spite of the fact that each process step is represented according to the present invention by exactly one activity container (see FIG. 2), the attribute “ActCont” in Table 90 is a foreign key with respect to a corresponding primary key in activity container 92. One reason for this is that an activity container may represent more than one process step. Another reason for this is that the remaining attributes of the process step are flow-orientated, whereas the attributes of an activity container are representation-orientated. In particular, the attributes “preAction,” “postAction,” and “Rule,” as shown in Table 90, are flow-orientated. Further attributes in the Table 90 may concern rights of a process step to its application data, such as createdrop, insertdelete, update or select\search\read-only. Further attributes that may be added to the activity container Table 92 are, for example, pre-settings concerning characteristics of a navigator menu, an operation mode, a reference to a documentation, or to a help container.

Table ActContActivities 93 shows the activities which are together in the activity container Table 92. Accordingly, the attribute ActCont is a foreign key on the primary key in the activity container Table 92 with the same name together with the attribute activity in the ActContActivities Table 93. This relationship is indicated by Arrow 94 in FIG. 9. The value 30 of attribute ActCont 30 in the ActContActivities Table 93 is related to the process step of the process 2, which is carried out first. In the depicted case, ActCont 30 is related to the activity 40 “customer contact.” This is shown in Activities Table 95, with the attributes Activity, Anode and ActivityName. Thus, as shown by Arrow 96 in FIG. 10, the foreign key Activity in the ActContActivities Table 93 references the primary key Activity in the Activities Table 95. Further attributes that can be added to the ActContActivities Table 93 are, for example, a presentation order of the respective activities; whether the respective activities are visible or not visible; whether the respective activity is a master activity or a child activity; whether there is an existent child activity; and whether there is no reference. The primary key in the Activities Table 95 is the attribute Activity. As indicated by Arrow 97, the attribute Anode, which is the foreign key in the Activities Table 95, references the primary key Anode in an Anode Table 98. Furthermore, as can be gathered from the Activities Table 95, a plurality of activities (in the depicted case, the activities 40 and 41) may refer to the same anode (here, 20) in the Anode Table 98. This is typical for a master anode or master activity.

The primary key in the Anode Table 98 is the attribute anode. This Anode Table 98 is the reference table for all anodes in the system. In this respect, it is also possible to specify in this Anode Table 98 all tables in the meta data definition storage 1. It should be noted that all necessary anodes for the respective process step have to be specified in this Anode Table 98.

The foreign key DataBase in Anode Table 98 references a primary key database in a DataBases Table 99. This is indicated by Arrow 100 in FIG. 10. Due to this, each anode has always exactly one unambiguous location. With the primary key database in the DataBases Table 99, each database actually used in a computer system installation is unambiguously specified. At least three databases always have to be specified, namely, the meta data definition storage 1, the runtime meta data storage 8, and the application data storage (here so called “local runtime anodes”). These databases are abbreviated as MDB, RMD, LocRAND, respectively. As can be gathered from the Anode Table 98 and the DataBases Table 99, the anode 20 “private customers” belongs to database 3 “LocRAND.” Further attributes that may be added to the database Table 99 comprise the database type that is, whether the database is relational, hierarchical, or a file system; the residence that is, whether the database is a local database or a remote database; and the type of interface, whether it is an ODBC or a JDBC interface, or a file class interface. All attributes concerning the respective database installation can be selected freely. This advantageously allows a high number of remote databases with a plurality of different types to be combined, to generate a basically unlimited number of anode definitions. In particular, all of these remote anodes can be mapped to local anodes where each remote anode may represent a separate database. This advantageously allows an easy and fast access to remote databases.

AnodeAtoms Table 101 shows the atoms of each anode. Accordingly, the attribute anode in the AnodeAtoms Table 101 is the foreign key to the primary key anode in the Anodes Table 98. For specifying the atoms of an anode, predefined atom types shown in the attribute AtomType in the AnodeAtoms Table 101 are used. The foreign key atom type in the AnodeAtoms Table 101 references a primary key atom type in an atom types Table 102. This is indicated in FIG. 10 by Arrow 103. As can be gathered from FIG. 10, the attribute AtomName in the AnodeAtoms Table 101 has the same entry or value as an attribute AtomTypeName in the AtomTypes Table 102. The attribute AtomType is the primary key in the AtomTypes Table 102. Furthermore, the AtomTypes Table 102 comprises an attribute ContentType. For each value or entry of this attribute, there is a method or rule for the validation of atoms that are derived from the atom type with this attribute value or entry. For example, the attribute content type “domain” specifies that the complete value range of the respective atom type is set forth in a further table in the meta database with the name “domains.” There could be a further table with the name “domain” which contains, for example, a list of all allowable academic titles. This table is not depicted in FIG. 10.

In an ActivityAtoms Table 104, the attributes Activity and AtomId are together primary key. A foreign key Activity references the primary key Activity in the Activities Table 95. A foreign key AtomId of the ActivityAtoms Table 104 references an attribute AtomId in the AnodeAtoms Table 101. This is set as default. The reason for this being set as default is that in case the atoms of an activity are inherited from their anodes, the attributes atom type and atom name in the ActivityAtoms Table 104 lapse. This default setting ensures that it can be decided unambiguously at runtime which activity is using which atom.

In case there is an entry in the column of the attribute atom type in the ActivityAtoms Table 103, this foreign key atom type references a primary key atom type in the AtomTypes Table 102. Then, there is also specified an atom name. This is shown by Arrow 105 in FIG. 10.

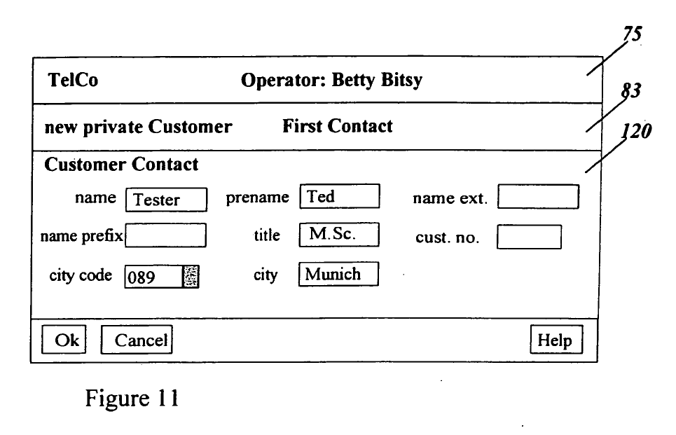

An attribute Label in the ActivityAtoms Table 104 specifies a text module that will be shown in the HTML representation of an activity for the respective label that is named. (See FIG. 11.) An attribute PresOrd indicates a sequence in which the HTML representation of the atoms shall be shown.

FIG. 11 shows the process step “first contact” of the process “new private customer” whose entries in the meta database are shown in FIG. 10 in its HTML representation as it appears on a screen of the user BETTY BITSY. Headers 75 and 83 have been modeled during the login procedure and during the process selection. Frame 120 is the HTML representation of the activity 40 as shown in the Activities Table 95. The name of this activity as set forth in the attribute ActivityName of the Activities Table 95 in FIG. 10 is stated in the upper left corner of frame 120. The labels Name, Name Prefix, City Code, Prename, Title, City, Name Ext., and Cust. No., are displayed in Frame 120 as shown in the ActivityAtoms Table 104 in the order as indicated in an attribute PresOrd in the ActivityAtoms Table 104 of activity 40. The fields of this HTML form are filled out by BETTY BITSY. The information written in these fields forms the respective atoms. The field Cust. No. is not an entry field; rather, the value of this field will be generated at the server after the HTML form has been sent back to the server. When a process step is completed, its data can be written in the respective application database; that is, in the anodes of the activities which are part of this process step.

FIG. 12 shows an exemplary anode for private customers, this anode here being represented as a table. This table is designated with Reference Number 150. Table 150 shows an attribute for each data entry carried out by BETTY BITSY in Frame 120 in FIG. 11. In other words, Table 150 has an attribute for each atom of Frame 120. Furthermore, Table 150 has an attribute ID which identifies this line 151 in Table 150. The attribute id is the primary key of Table 150. Furthermore, Table 150 has an attribute state. Attribute states may have the value zero, indicating that the respective line 151 in Table 150, i.e., the record of the respective customer, is incomplete; the attribute state may have the value one, indicating that the record is actual; or, the attribute state may have a value greater than one, indicating that the record actually stated in the corresponding line is a historical record. Furthermore, Table 150 has an attribute stamp which is a time-stamp, and an attribute todo. The four attributes: id, state, stamp, and “todo”, advantageously allow any anode structure to be administrated.

As previously described with reference to FIG. 6, an efficient search engine can be implemented with this structure. As stipulated by search descriptors 61, description string 62 that is characteristic of Record 151 is generated from the concrete values of this record on the meta data level. The generation process is denoted by the two arrows 152. The respective description string 62 containing the customer number cust. no., the name, the prename and the city code as set forth in this record is then stored in the runtime meta data storage 8.

While the present invention has been described in connection with the foregoing representative embodiments, it should be readily apparent to those of ordinary skill in the art that the representative embodiments are exemplary in nature and are not to be construed as limiting the scope of protection for the invention as set forth in the appended claims.

I claim:

1. A computer system for automatically generating a process step, comprising:
a meta data definition storage containing a definition of the process step to be generated and a first function;
a process generator for generating the process step on the basis of the definition in the meta data definition storage;
an application data storage for storing application data, the application data being linked in accordance with a data logic;
a runtime meta data storage for storing the data logic of the application data; and
a runtime environment for accessing the application data on the basis of the data logic and executing the process step using the application data by means of the first function specified in the meta data definition storage.

2. The computer system of claim 1, further comprising:
a runtime kernel; and
an application shell;
wherein the runtime kernel and the application shell are part of the runtime environment, and wherein the runtime environment determines whether the first function is a standardized, application-independent function or an application-dependent function, and wherein the runtime kernel executes the first function when the first function is a standardized, application-independent function, and wherein the application shell executes the first function when the first function is an application-dependent function.

3. The computer system of claim 1, wherein the first function is specified in the meta data definition storage by at least one of execution timing meta data, execution location data, a call and a statement string.

4. The computer system of claim 1, wherein the runtime environment acquires the data logic of the application data and stores the acquired data logic in the runtime meta database.

5. The computer system of claim 4, wherein the data logic is acquired as anode links, the anode links representing connections amongst a plurality of data items in an application data storage.

6. A method of generating a process step, comprising the steps of:
selecting a definition of the process step to be generated from a meta data definition storage;
generating the process step on the basis of the definition selected from the meta data definition storage;
reading out a specification of a first function to be implemented in a runtime environment from the meta data definition storage;
reading out a data logic of application data from a runtime meta database;
accessing application data on the basis of the data logic stored in the runtime meta database; and
executing the process step in the runtime environment using the application data by means of the specification of the first function read out from the meta data definition storage.

7. The method of claim 6, further comprising:
determining whether the first function is a standardized, application-independent function or an application-dependent function;
executing the first function on a runtime kernel in the runtime environment if the first function is a standardized, application-independent function; and
executing the first function on an application shell in the runtime environment if the first function is an application-dependent function.

8. The method of claim 6, wherein the specification of the first function to be implemented in the runtime environment from the meta data definition storage comprises at least one of execution timing meta data, execution location data, a call and a statement string.

9. The method of claim 6, further comprising:
acquiring the data logic of the application data; and
storing the acquired data logic in the runtime meta database.

10. The method of claim 9, wherein the data logic is acquired as anode links, the anode links representing connections amongst a plurality of data items.

11. A computer memory encoded with executable instructions representing a computer program for generating a process step, comprising
means for selecting a definition of the process step to be generated from a meta data definition storage;
means for generating the process step on the basis of the definition selected from the meta data definition storage;
means for reading out a specification of a first function to be implemented- in a runtime environment from the meta data definition storage;
means for reading out a data logic of application data from a runtime meta database;
means for accessing application data on the basis of the data logic stored in the runtime meta database; and
means for executing the process step in the runtime environment using the application data by means of the specification of the first function read out from the meta data definition storage.

12. The computer memory of claim 11, further comprising:
means for determining whether the first function is a standardized, application-independent function or an application-dependent function;
means for executing the first function on a runtime kernel in the runtime environment if the first function is a standardized, application-independent function; and
means for executing the first function on an application shell in the runtime environment if the first function is an application-dependent function.

13. The computer memory of claim 1, wherein the specification of the first function to be implemented in the runtime environment from the meta data definition storage comprises at least one of execution timing meta data, execution location data, a call and a statement string.

14. The computer memory of claim 1, further comprising:
means for acquiring the data logic of the application data; and
means for storing the acquired data logic in the runtime meta database.

15. The computer memory of claim 14, wherein the data logic is acquired as anode links, the anode links representing connections-amongst a plurality of data items.

16. A computer-readable medium for storing a plurality of instruction sets for causing a computer system to generate a process step by performing the steps of:
selecting a definition of the process step to be generated from a meta data definition storage;
generating the process step on the basis of the definition selected from the meta data definition storage;
reading out a specification of a first function to be implemented in a runtime environment from the meta data definition storage;
reading out a data logic of application data from a runtime meta database;
accessing application data on the basis of the data logic stored in the runtime meta database; and
executing the process step in the runtime environment using the application data by means of the specification of the first function read out from the meta data definition storage.

17. The computer-readable medium of claim 16, wherein the computer system is caused to perform the further steps of:
determining whether the first function is a standardized, application-independent function or an application-dependent function;
executing the first function on a runtime kernel in the runtime environment if the first function is a standardized, application-independent function; and
executing the first function on an application shell in the runtime environment if the first function is an application-dependent function.

18. The computer-readable medium of claim 16, wherein the specification of the first function to be implemented in the runtime environment from the meta data definition storage comprises at least one of execution timing meta data, execution location data, a call and a statement string.

19. The computer-readable medium of claim 16, wherein the computer system is caused to perform the further steps of:
acquiring the data logic of the application data; and
storing the acquired data logic in the runtime meta database.

20. The computer-readable medium of claim 19, wherein the data logic is acquired as anode links, the anode links representing connections amongst a plurality of data items.
